(19) United States
(12) Patent Application Publication
(10) Pub. No.: US 2016/0071153 A1
(43) Pub. Date: Mar. 10, 2016

(54) Presenting Additional States of Content Items to Users Based on Received Inputs

(71) Applicant: Facebook, Inc., Menlo Park, CA (US)

(72) Inventors: Fidji Nahema Simo, Palo Alto, CA (US); Asad K. Awan, San Francisco, CA (US); Jessica Marie Watson, San Francisco, CA (US)

(21) Appl. No.: 14/479,081

(22) Filed: Sep. 5, 2014

(51) Int. Cl. G06Q 30/02; H04L 29/08

(52) U.S. Cl. CPC G06Q 30/0257; H04L 67/02

(57) ABSTRACT

An online system allows an entity to generate a content item having multiple states, with each state including different content. When a user interacts with the content item, a different state of the content item is identified and content associated with the different state is presented to the user. For example, if the user contacts a portion of a display device presenting the content item, content from a different state of the content item is presented. If the content item is an advertisement request, the online system may charge the entity an amount depending on whether content associated with various states of the content item was presented to a user.

### BACKGROUND

This disclosure relates generally to online systems, and more specifically to selecting content to present to online system users.

An online system, such as a social networking system, allows its users to connect to and communicate with other online system users. Users may create profiles on an online system that are tied to their identities and include information about the users, such as interests and demographic information. The users may be individuals or entities such as corporations or charities. Because of the increasing popularity of online systems and the increasing amount of user-specific information maintained by online systems, an online system provides an ideal forum for entities, such as retailers or service providers, to increase awareness about products or services by presenting content to online system users.

Presenting content items to online system users allows an entity (e.g., a retailer, a service provider, a restaurant) to gain public attention for products or services or to persuade online users to take an action regarding the entity's products or services. Additionally, many online systems generate revenue by receiving compensation from entities for presenting certain content items to their users. Frequently, online systems charge an entity for each presentation of certain types of content items to an online system user (e.g., each “impression” of the content item) or for each interaction with certain types of content items by an online system user.

Conventionally, an entity provides a content item describing a product or a service to an online system. The content item includes information describing the product or the service for presentation to online system users. Frequently, a limited amount of information describing a product or a service is included in a content item, which may be insufficient to capture a user's interest. While providing additional information about a product or service may increase the likelihood of a user purchasing the product or service, conventional online systems require an entity to provide a larger content item to accommodate the additional information. This may displace other content items presented by the online system, which may discourage the user from continued interaction with the online system.

### SUMMARY

An online system receives a content item including a plurality of states for presentation to one or more online system users. Each state of the content item is associated with different content, with one or more components included in the content. Example components of content include: text data, video data, audio data, image data, a network address (e.g., a link), or any other content suitable for presentation. The content item also includes information identifying one or more interactions that, when received by a client device presenting the content item, cause the content item to present content associated with a different state than a state associated with content currently presented.

When the online system selects the content item for presentation to a user of the online system, the content item is communicated from the online system to a client device associated with the user for presentation. For example, the online system communicates the content item to the client device when the user accesses the online system via the client device or if the client device communicates a request for content to the online system. The client device receives the content item having the plurality of states and displays content associated with a state of the content item to the user. In one embodiment, the state displayed by the client device is specified by a user (e.g., an advertiser, another user of the online system) that provided the content item to the online system. If the client device receives an input from the user interacting with the content associated with the state of the content item, an additional state of the content item is identified and content associated with the additional state is displayed via the client device. The content associated with the additional state differs at least in part from the content associated with the state of the content item. For example, the content associated with the additional state has one or more components differing from components of content associated with the state. As another example, an attribute of a component associated with content associated with the additional state differs from an attribute of the component associated with content associated with the state. Example attributes of a component include volume of an audio component, size of images, color schemes of images, font style of text components, font size of text components, font color of text components, font spacing of text components, speed of play of a video component, or any other suitable modification to a component.

In one embodiment, when the client device presents the content item to the user, the client device sends an indication to the online system indicating the content associated with the state was presented. If an input with the content item is received, the client device also sends an indication to the online system that the input was received. The indication sent to the online system may be a signal (e.g., binary), a flag, a timestamp, a description of the input, or any other suitable signal indicating an input was received for content of the state of the content item. If the received input is an interaction such as a gesture, the client device sends the indication to the online system when the gesture is completed. Additionally, the indication that content associated with the state or the indication that input with the content item was received, the indication may include an identifier of the user. Additionally, the client device sends an additional indication to the online system if the content associated with the additional state. In various embodiments, the client device may similarly send an indication to the online system if an input interacting with the content item was received when the content associated with the additional state was presented.

If the content item is an advertisement, the online system determines an amount of compensation to charge an advertiser associated with the advertisement. The amount charged may be based on whether the content associated with the additional state was displayed. For example, the advertiser is charged a larger amount if the content associated with the additional state was displayed than if the content associated with the state was displayed but the content associated with the additional state was not displayed. In various embodiments, whether the advertiser is charged using a cost per impression or a cost per click basis, the amount charged to the advertiser or whether an impression of the advertisement or an interaction with the advertisement is identified depends on whether content associated with one or more additional states of the advertiser were presented to the user.

### BRIEF DESCRIPTION OF THE DRAWINGS

FIG. 1 is a block diagram of a system environment in which an online system operates, in accordance with an embodiment.

FIG. 2 is a block diagram of an online system, in accordance with an embodiment.

FIG. 3 is an interaction diagram of a method for presenting content associated with various states of a content item to users of an online system, in accordance with an embodiment.

FIGS. 4A-4B are examples of content associated with different states of a content item presented to a user by an online system, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

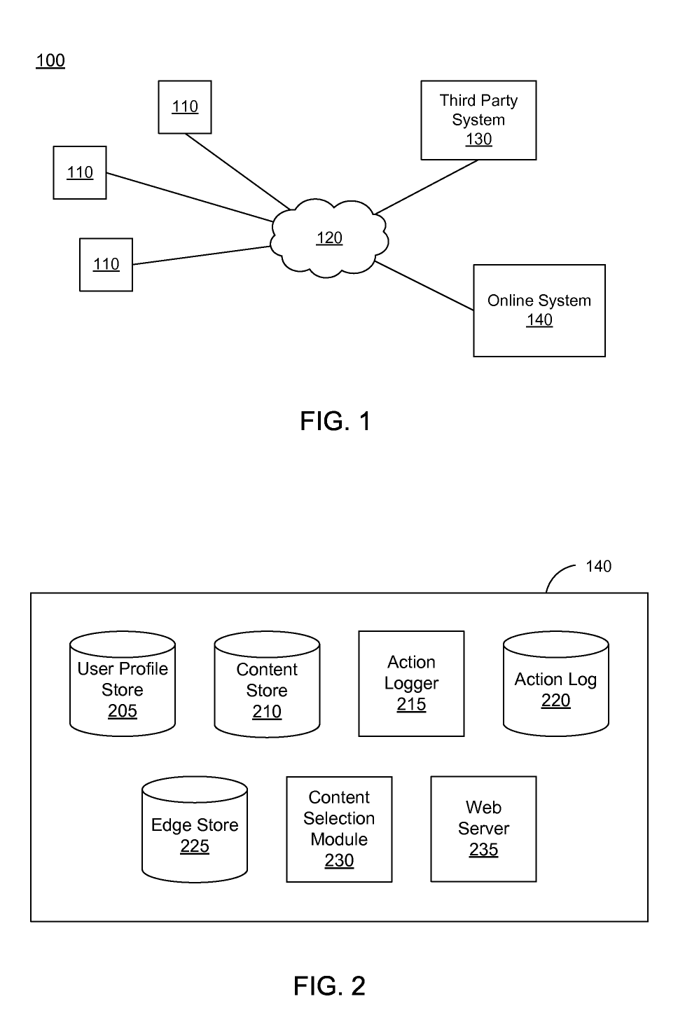

FIG. 1 is a block diagram of a system environment 100 for an online system 140, such as a social networking system. The system environment 100 shown by FIG. 1 comprises one or more client devices 110, a network 120, one or more third-party systems 130, and the online system 140. In alternative configurations, different and/or additional components may be included in the system environment 100.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone or another suitable device. A client device 110 is configured to communicate via the network 120. In one embodiment, a client device 110 executes an application allowing a user of the client device 110 to interact with the online system 140. For example, a client device 110 executes a browser application to enable interaction between the client device 110 and the online 140 via the network 120. In another embodiment, a client device 110 interacts with the online system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the online system 140, which is further described below in conjunction with FIG. 2. In one embodiment, a third party system 130 is an application provider communicating information describing applications for execution by a client device 110 or communicating data to client devices 110 for use by an application executing on the client device. In other embodiments, a third party system 130 provides content or other information for presentation via a client device 110. A third party website 130 may also communicate information to the online system 140, such as advertisements, content, or information about an application provided by the third party website 130.

FIG. 2 is a block diagram of an architecture of the online system 140. The online system 140 shown in FIG. 2 includes a user profile store 205, a content store 210, an action logger 215, an action log 220, an edge store 225, content selection module 230, and a web server 235. In other embodiments, the online system 140 may include additional, fewer, or different components for various applications. Conventional components such as network interfaces, security functions, load balancers, failover servers, management and network operations consoles, and the like are not shown so as to not obscure the details of the system architecture. In one embodiment, the online system 140 is a social networking system.

Each user of the online system 140 is associated with a user profile, which is stored in the user profile store 205. A user profile includes declarative information about the user that was explicitly shared by the user and may also include profile information inferred by the online system 140. In one embodiment, a user profile includes multiple data fields, each describing one or more attributes of the corresponding online system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying online system users displayed in an image. A user profile in the user profile store 205 may also maintain references to actions by the corresponding user performed on content items in the content store 210 and stored in the action log 220.

While user profiles in the user profile store 205 are frequently associated with individuals, allowing individuals to interact with each other via the online system 140, user profiles may also be stored for entities such as businesses or organizations. This allows an entity to establish a presence on the online system 140 for connecting and exchanging content with other online system users. The entity may post information about itself, about its products or provide other information to users of the online system using a brand page associated with the entity's user profile. Other users of the online system may connect to the brand page to receive information posted to the brand page or to receive information from the brand page. A user profile associated with the brand page may include information about the entity itself, providing users with background or informational data about the entity.

The content store 210 stores objects that each represent various types of content. Examples of content represented by an object include a page post, a status update, a photograph, a video, a link, a shared content item, a gaming application achievement, a check-in event at a local business, a brand page, or any other type of content. Online system users may create objects stored by the content store 210, such as status updates, photos tagged by users to be associated with other objects in the online system 140, events, groups or applications. In some embodiments, objects are received from third-party applications or third-party applications separate from the online system 140. In one embodiment, objects in the content store 210 represent single pieces of content, or content “items.” Hence, online system users are encouraged to communicate with each other by posting text and content items of various types of media to the online system 140 through various communication channels. This increases the amount of interaction of users with each other and increases the frequency with which users interact within the online system 140.

The content store 210 may also store one or more advertisement (“ad”) requests. Alternatively, ad requests are included in an ad store separate from the content store 210. An ad request is received from an advertiser for presentation to users of the online system 140 and the ad request may be included in an advertisement campaign (“ad campaign”) by the advertiser. Each ad request includes advertisement content (“ad content”), which is ad content presented to an online system user. Ad content may be text data, image data, audio data, video data, or any other suitable data. Additionally, ad content may include a link or destination address associated with a source of content associated with the ad request that is presented to the user if the user accesses the ad content when it is presented. For example, the destination address identifies a landing page including content that is presented to the user when the user accesses the ad content.

Additionally, an ad request include a bid amount specifying an amount of compensation an advertiser associated with the ad request provides the online system 140 for presenting the ad content, for a user interacting with presented ad content, or for another suitable interaction with presented ad content by a user. Based on the bid amount included in an ad request, the online system 140 determines an expected value for presenting ad content in the ad request to a user. For example, the expected value is an amount of monetary compensation received by the online system 140 from an advertiser for presenting the advertisement to a user, for a user interacting with the presented ad content, or based on any other suitable condition. In one embodiment, the expected value of an ad request is a product of the bid amount and a probability of the ad content of the ad request being accessed by the user if presented.

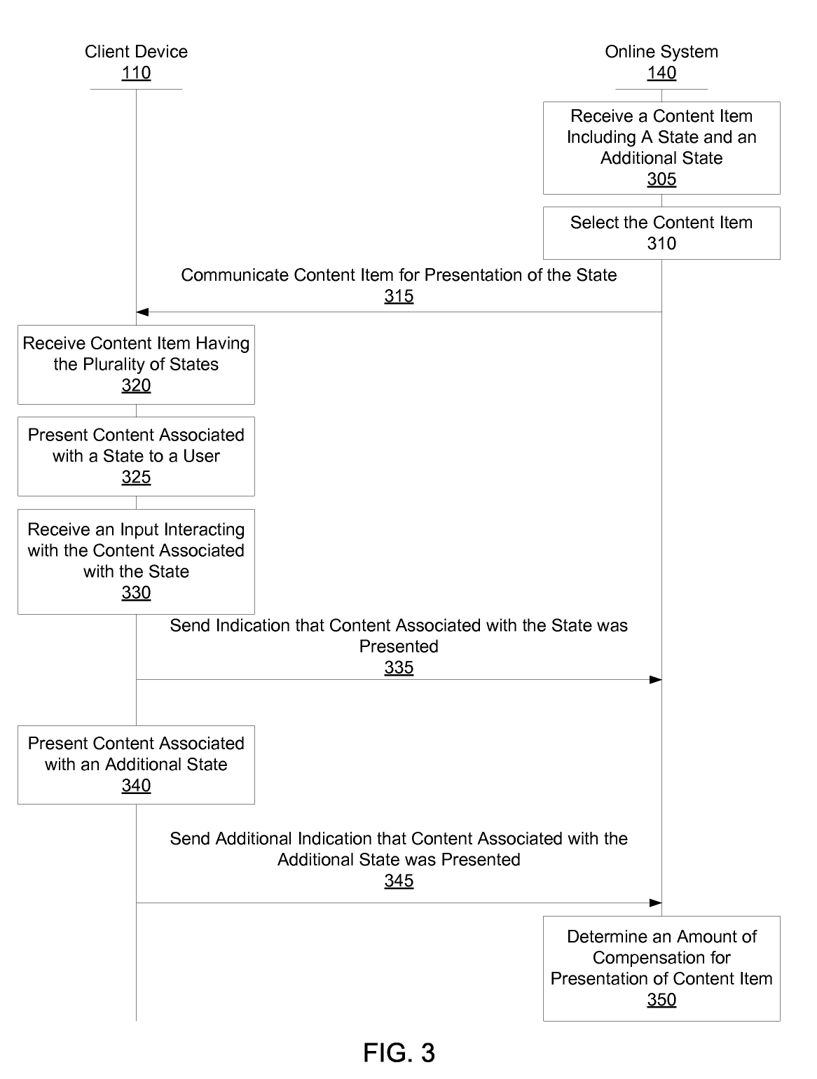

A bid amount associated with an ad request may be based on a type associated with the ad request. The type associated with an ad request may be based at least in part on the format with which ad content included in the ad request is displayed or the type of information presented by the ad content. For example, a type of ad request includes ad content describing a single product or service. Another type of ad request includes ad content describing multiple products or services. Additionally, an alternative type of ad request includes multiple states with different content associated with each state and identifies an interaction with advertisement content causing display of content associated with one or more states. Another type of ad request may include multiple components of ad content and an order in which the various components are presented to a user. A bid amount associated with an ad request may be proportional to the number of states identified by the ad request associated with content presented to the user. Multiple bid amounts may be associated with an ad request. For example, a bid amount is associated with an ad request if content associated with a state is presented and an additional bid amount is associated with the ad request if content associated with an additional state is presented. Presentation of content associated with different states specified by an ad request is further described below in conjunction with FIG. 3.

Additionally, ad requests may be associated with one or more targeting criteria. An advertiser may specify targeting criteria associated with an ad request or may specify targeting criteria associated with multiple ad requests included in an ad campaign. Targeting criteria specify one or more characteristics of users eligible to be presented with an ad content included in an ad request associated with the targeting criteria. Associating different targeting criteria with different ad requests allows an advertiser to tailor presentation of ad content to users having specific characteristics, allowing ad requests including different ad content to be presented to users with different characteristics. For example targeting criteria specify demographic information, connections, or actions associated with a user. In some embodiments, targeting criteria may be associated with an ad campaign in its entirety, so multiple ad requests in the ad campaign are associated with the targeting criteria.

In one embodiment, targeting criteria may specify actions or types of connections between a user and another user or object of the online system 140. Targeting criteria may also specify interactions between a user and objects performed external to the online system 140, such as on a third party system 130. For example, targeting criteria identifies users that have taken a particular action, such as sending a message to another user, using an application, joining a group, leaving a group, joining an event, generating an event description, purchasing or reviewing a product or service using an online marketplace, requesting information from a third-party system 130, or any other suitable action. Including actions in targeting criteria allows advertisers to further refine users eligible to be presented with ad content from various ad requests. As another example, targeting criteria identifies users having a connection to another user or object or having a particular type of connection to another user or object.

Additionally, an ad request may include an objective specifying a goal of the advertiser for presentation of the ad content in the ad request to online system users. The objective may also be associated with an ad campaign including the ad request to specify a goal of the advertiser for other ad requests in the ad campaign as well as the ad request. For example, the objective identifies a type of interaction with ad content from ad requests included in the ad campaign or with one or more objects associated with ad requests in the ad campaign by online system users presented with ad content from the ad campaign. Examples of objectives include: online system users accessing presented ad content (e.g., clicking or otherwise accessing the advertisement), online system users installing an application associated with the ad content, online system users expressing a preference for a page associated with the ad content (i.e., “liking” the page), online system users viewing a page associated with the ad content or with the ad campaign, or any other suitable action by online system users. In one embodiment, the objective is selected from a set of objectives maintained by the online system 140.

Additional information may be associated with an ad request or with the ad campaign including the ad request. For example, the ad request or ad campaign includes a budget that specifies a total amount of compensation an advertiser provides the online system 140 for presenting ad content included in the ad request or included in ad requests associated with an ad campaign. The budget may be allocated for the ad campaign as a whole or per ad request. In addition, the advertiser may specify instructions for allocating the budget among various ad requests in the ad campaign. For example, the instructions specify modification of a bid amount associated with an ad request included in the ad campaign based on one or more criteria. The instructions may also include other suitable information describing allocation of a budget among ad requests included in the ad campaign.

The action logger 215 receives communications about user actions internal to and/or external to the online system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with those users as well and stored in the action log 220.

The action log 220 may be used by the online system 140 to track user actions on the online system 140, as well as actions on third party systems 130 that communicate information to the online system 140. Users may interact with various objects on the online system 140, and information describing these interactions is stored in the action log 220. Examples of interactions with objects include: commenting on posts, sharing links, and checking-in to physical locations via a mobile device, accessing content items, and any other interactions. Additional examples of interactions with objects on the online system 140 that are included in the action log 220 include: commenting on a photo album, communicating with a user, establishing a connection with an object, joining an event, joining a group, creating an event, authorizing an application, using an application, expressing a preference for an object (“liking” the object) and engaging in a transaction. Additionally, the action log 220 may record a user's interactions with advertisements on the online system 140 as well as with other applications operating on the online system 140. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the online system 140. For example, an e-commerce website may recognize a user of an online system 140 through a social plug-in enabling the e-commerce website to identify the user of the online system 140. Because users of the online system 140 are uniquely identifiable, e-commerce websites, such as in the preceding example, may communicate information about a user's actions outside of the online system 140 to the online system 140 for association with the user. Hence, the action log 220 may record information about actions users perform on a third party system 130, including webpage viewing histories, advertisements that were engaged, purchases made, and other patterns from shopping and buying.

In one embodiment, the edge store 225 stores information describing connections between users and other objects on the online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page on the online system 140, sharing a link with other users of the online system 140, and commenting on posts made by other users of the online system 140.

In one embodiment, an edge may include various features each representing characteristics of interactions between users, interactions between users and objects, or interactions between objects. For example, features included in an edge describe rate of interaction between two users, how recently two users have interacted with each other, the rate or amount of information retrieved by one user about an object, or the number and types of comments posted by a user about an object. The features may also represent information describing a particular object or user. For example, a feature may represent the level of interest that a user has in a particular topic, the rate at which the user logs into the online system 140, or information describing demographic information about a user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the online system 140 over time to approximate a user's interest in an object, a topic, or another user in the online system 140 based on the actions performed by the user. A user's affinity may be computed by the online system 140 over time to approximate the user's interest in an object, a topic, or another user in the online system 140 based on the actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

The content selection module 230 selects one or more content items for communication to a client device 110 to be presented to a user. In various embodiments, the content selection module 230 determines a measure of relevance of various content items to the user based on characteristics associated with the user by the online system 140 based on the user's affinity for different content items and selects content items for presentation to the user based on the determined measures of relevance. For example, the content selection module 230 selects content items having the highest measures of relevance or having at least a threshold measure of relevance for presentation to the user. Alternatively, the content selection module ranks content items based on their associated measures of relevance and selects content items having the highest positions in the ranking or having at least a threshold position in the ranking for presentation to the user.

Content items selected for presentation to the user may include ad content. When selecting ad content, the content selection module 230 uses bid amounts associated with various ad requests. In various embodiments, the content selection module 230 determines an expected value associated with various ad requests and selects ad requests associated with a maximum expected value or at least a threshold expected value for presentation. An expected value associated with an ad request represents an expected amount of compensation to the online system 140 for presenting ad content from the ad request. For example, the expected value associated with an ad request is a product of the ad request's bid amount and a likelihood of the user interacting with the ad content from the ad request. The content selection module 230 may rank ad requests based on their associated bid amounts and select ad requests having at least a threshold position in the ranking for presentation to the user. In some embodiments, the content selection module 230 may rank both content items and ad requests in a unified ranking based on bid amounts associated with ad request and measures of relevance associated with content items and ad requests. Based on the unified ranking, the content selection module 230 selects content for presentation to the user. Selecting ad requests and other content items through a unified ranking is further described in U.S. patent application Ser. No. 13/545,266, filed on Jul. 10, 2012, which is hereby incorporated by reference in its entirety.

If ad content is selected for presentation to the user, the content selection module 230 also determines an amount of compensation the online system 140 requests from an advertiser associated with the selected ad content. For example, the amount of compensation is based on bid amounts or expected values associated with one or more additional ad requests that were not selected for presentation to the user. Additionally, if an ad request selected for presentation includes ad content having multiple states, the content selection module 230 may account for a number of states associated with content presented to the user when determining the amount of compensation for the online system 140 to receive. For example, the content selection module 230 determines a larger amount of compensation is to be received if content associated with multiple states specified by an ad request is presented than if content associated with a single state specified by the ad request is presented. Presentation of an ad request including multiple states as well as determination of an amount of compensation to receive from presentation of ad content associated with different states is further described below in conjunction with FIG. 3.

The web server 235 links the online system 140 via the network 120 to the one or more client devices 110, as well as to the one or more third party systems 130. The web server 140 serves web pages, as well as other web-related content, such as JAVA®, FLASH®, XML and so forth. The web server 235 may receive and route messages between the online system 140 and the client device 110, for example, instant messages, queued messages (e.g., email), text messages, short message service (SMS) messages, or messages sent using any other suitable messaging technique. A user may send a request to the web server 235 to upload information (e.g., images or videos) that are stored in the content store 210. Additionally, the web server 235 may provide application programming interface (API) functionality to send data directly to native client device operating systems, such as IOS®, ANDROID™, WEBOS® or BlackberryOS.

Displaying a Content Item Including Different Content Associated with Different States

FIG. 3 is an interaction diagram of one embodiment of a method for presenting content associated with various states of a content item to a user of an online system 140. In other embodiments, the method may include different and/or additional steps than those shown in FIG. 3. Additionally, in some embodiments, the steps described in conjunction with FIG. 3 may be performed in different orders than the order described in conjunction with FIG. 3.

The online system 140 receives 305 a content item for presentation to one or more users that includes a plurality of states. For example, the content item is received 305 from an advertiser, but may be received from any user of the online system 140. Each state of the content item is associated with content, with different content associated with different states. Content associated with a state includes various components. Example components include: text data, video data, audio data, image data, a network address (e.g., a link to a source), or any other suitable content for presentation to a user. In one embodiment, content associated with different states of a content item is not displayed simultaneously, but content associated with different states is presented in response to a user interacting with the content item. For example, the content item presents content associated with a state, and when an interaction with the content item is detected or received, content associated with an additional state is presented. The content item may include a sequence of states, where content associated with a state in the sequence is presented to a user after the user interacts with another state having an earlier position in the sequence. Additionally, the content item may be included in a sequence of content items, where content items are presented to a user based on their position in the sequence, with later content items in the sequence presented after earlier content items in the sequence are presented. The received content item is stored, for example, in the content store 210.

When selecting content for presentation to the user, the online system 140 selects 310 the content item. As described above in conjunction with FIG. 2, the online system 140 selects 310 content for presentation to the user based at least in part on measures of affinity between the user and various content items. In various embodiments, the content item is selected 310 if the measure of affinity between the user and the content item is at least a threshold value. Alternatively, the online system 140 ranks content items based at least in part on the measures of affinity between the user and various content items and selects 310 the content item if it has at least a threshold position in the ranking. If the content item is an ad request, a bid amount associated with the ad request is used by the online system 140 when selecting content for presentation. For example, the online system 140 determines an expected value associated with the content item based on its bid amount and a likelihood of the user interacting with ad content included in the expected value. If the content item is associated with at least a threshold expected value or has at least a threshold expected value, it is selected 310 for presentation. As another example, the online system 140 ranks ad requests based on their associated expected values, and if the content item has at least a threshold position in the ranking, it is selected 310 for presentation. In some embodiments, a position of the content item in a ranking is increased based on a number of states included in the content item, which may increase the likelihood of the content item being selected 310 for presentation. If the content item is included in a sequence of content items, whether content items having earlier positions in the sequence have been presented to the user determines whether the content item is eligible to be selected 310 for presentation; in various embodiments, a content item in a sequence is not ranked unless one or more content items having earlier positions in the sequence have previously been presented to the user.

In some embodiments, after selecting 310 the content item for presentation, the online system 140 may also select content associated with one of more of the states included in the content item for presentation. For example, the content item associates characteristics with different states, so the online system 140 compares characteristics of the user with characteristics associated with states included in the content item and selects states associated with a maximum number of characteristics matching characteristics associated with the user. In one embodiment, the online system 140 selects a state initially presented to the user based on the characteristics of the user and characteristics associated with states of the content item; the online system 140 may similarly select an order in which states of the content item are presented. For example, the online system 140 limits presentation of content from the content item to content associated with states that are associated with an age that equals or exceeds an age of the user. In another example, actions associated with the user by the online system 140 indicate that the user dislikes one or more topics, so the online system 140 does not select one or more states of the content item associated with the one or more topics. As another example, information in the content item identifies characteristics of one or more users not to be presented with a state of the content item, so the state is not selected for presentation to the user if the user is associated with at least a threshold number of the identified characteristics.

The online system 140 communicates 315 the content item to a client device 110 associated with the user for presentation. For example, the content item is communicated 315 to the client device 110 in response to the online system 140 receiving a request for content from the client device 110. As another example, the online system 140 periodically communicates 315 content to the client device 110.

When the client device 110 receives 320 the content item including the plurality of states, the client device 110 presents 325 content associated with a state of the content item. As previously described, the presented content comprises one or more components associated with the state. In various embodiments, the state associated with the initially presented content is specified by the user that provided the content item to the online system 140 or the state associated with the initially presented content is determined by the online system 140. The content item may be presented 325 along with other content provided by the online system 140. For example, the content item is presented 325 in a feed of multiple content items.

While the content item is presented 325, the client device 110 receives 330 an input from the user interacting with the presented content associated with the state of the content item. Examples of the received input include clicking on the content item via a mouse, touching the content item via a touch-sensitive display device of the client device 110, receiving an audio command to access the content item, or any other suitable input. As another example, the interaction is a gesture where the user contacts a portion of a display device of a client device 110 presenting the content item with a physical stylus and continues contacting the display device with the physical stylus along a specified path, the client device 110 receives 330 the input when the gesture is completed (e.g., the stylus remains static for at least a threshold time interval or the stylus stops contacting the display device).

Additionally, the client device 110 sends 335 an indication to the online system 140 that content associated with the state was presented 315. In some embodiments, the indication may be sent 335 when the content associated with the state is presented or after the content associated with the state has been presented for at least a threshold amount of time. Alternatively, the client device 110 sends 335 the indication in response to receiving 330 the input interacting with the content associated with the state. The indication sent 335 to the online system 140 may be a signal (e.g., a binary value), a flag, a timestamp, or any other suitable signal indicating an input was received interacting with the content associated with the state of the content item or that an interaction was received 330 with the content associated with the state. For example, if the interaction such as a gesture is sent 335 when the interaction is received 330, the indication is sent 335 in response to a physical stylus traversing the display device a threshold distance associated with the gesture. If the interaction is sent 335 when the content associated with the state is displayed or when an interaction with the content associated with the state is received, the indication sent 335 may depend on a type of the content item. For example, if the content item is an ad request associated with cost per impression pricing, the indication is sent 335 when the content associated with the state is presented 315, while the indication is sent 335 when the interaction is received 320 if the content item is an ad request associated with cost per click or cost per action pricing. The indication may include an identifier of the user, an identifier associated with the client device 110, a description of the received input, an identification of the state associated with content presented 325 to the user, or any other suitable information.

In another embodiment, the client device 110 sends an indication to the online system 140 when an action associated with the content associated with the state is received from the user and sends 335 another indication after the input was received 330. If the received input is an action associated with the content item, the type of action is identified by an indication sent 335 after the input was received. Examples of actions associated with the content item include the user indicating a preference for the content item (“liking” the content item), the user sharing the content item with another user, the user commenting on the content item, or any other suitable type of action. Another indication is then sent 335 when an input to present content associated with another state is received 330. If the content item is advertisement content the online system 140 may determine an amount of compensation to request from an advertiser based at least in part on the type of action associated with the content item that was identified.

After receiving 330 the input interacting with the content associated with the state, the client device 110 presents 340 content associated with an additional state of the content item. For example, the client device 110 identifies the additional state from the received content item and presents 340 content associated with the additional state. The additional state may be identified based on one or more actions associated with the content item or a type of the received input with the content associated with the state. In other embodiments, the additional state is determined based on a sequence of states associated with the content item, allowing the user providing the content item to the online system 140 to specify an order in which states are presented by the content item. For example, when an input interacting with a state associated with a position in the sequence is received 330, a state associated with a subsequent position in the sequence is presented 340. Alternatively, the client device 110 communicates to the online system 140 information indicating that the input was received 330, and the online system 140 communicates an identification of the additional state to the client device 110 or communicates content associated with the additional state to the client device 110 for presentation.

The displayed content associated with the additional state differs at least in part from the content associated with the state of the content item. In various embodiments, one or more components of content associated with the additional state differ from components of content associated with the state. For example, if the content associated with the state is a picture of a walrus, the content associated with the additional state is a different picture, the picture of the walrus as well as a text component, or any other suitable combination of components with at least one differing component. In another example, one or more attributes of a component differ between the state and the additional state. Example attributes of a component include size of an image, resolution of an image, volume of audio data, colors associated with text or with images, font used to present text data, font sizes used to present text data, speed at which video data is played, and resolution of video data; however, any suitable characteristic describing presentation of content may be an attribute of the content. For example, if content associated with the state is a small image of a walrus, the content associated with the additional state is a larger image of the walrus.

The client device 110 sends 345 an additional indication to the online system 140 indicating content associated with the additional state was presented 340. In various embodiments, the client device 110 sends 345 the additional indication to the online system 140 when an input interacting with the content associated with the additional state is received. Alternatively, the client device 110 sends 345 the additional indication when the content associated with the additional state is presented 340 and sends another indication when an input interacting with the content associated with the additional state is received. The additional indication may be a signal (e.g., a binary value), a flag, a timestamp, or any other suitable signal. The additional indication may include an identifier of the user, an identifier associated with the client device 110, a description of a type of input received with the content associated with the additional state, or any other suitable information.

If the content item is an ad request, the content associated with the state and with the additional state is advertisement content and the online system 140 determines 350 an amount of compensation to charge an advertiser associated with the content item. The amount may be based at least in part on whether content associated with multiple states of the content item was presented. Hence, the amount may be determined 350 based on the indication and/or the additional indication received by the online system 140. For example, if the additional indication was received, the online system 140 determines an additional impression of the content item occurred and may identify an additional impression of the content item when the content associated with the additional state is presented 345 or may identify an additional interaction with the content item if content associated with the additional state is presented 345. The amount charged to the advertiser may be based on the number of states associated with content presented via the client device 110; for example, the amount charged is proportional to a number of states associated with presented content or different amounts are charged depending on whether a threshold number of a threshold percentage of states are associated with presented content, or based on any other suitable information.

### Presentation of States of a Content Item

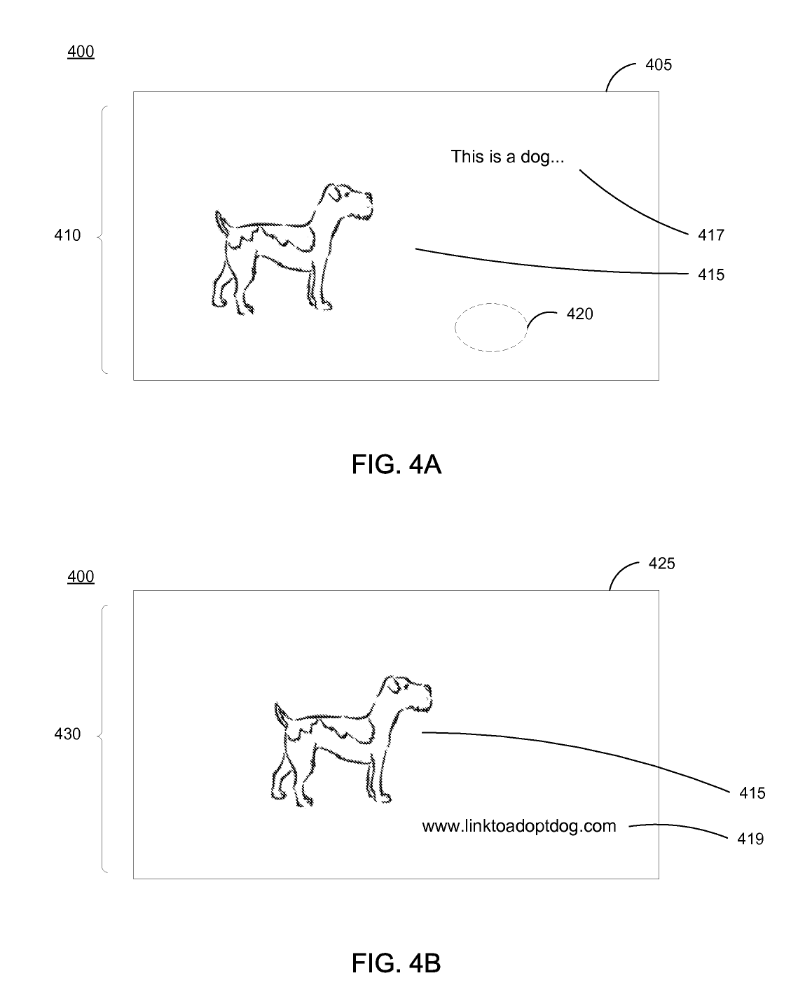

FIGS. 4A and 4B are examples of a content item 400 including different states each associated with different content presented to an online system user. Initially, content 410 associated with a state 405, shown in FIG. 4A, of the content item 400 is presented to the user. When an input interacting with the content item 400 is received by a client device 110 presenting content associated with the state 400, content 430 associated with an additional state 425 of the content item 400 is presented. In the example of FIG. 4A, the content 410 associated with the state 405 includes an image 415 of a dog as well as text content 417 reading “this is a dog.” The image 415 and the text content 417 are components of the content 410 associated with the state 405.

When an input 420 interacting with the content 410 is received from the user, an indication is communicated form the client device 110 presenting the content 410 to the online system 140. The additional state 425 is also identified by the client device 110, and content 430 associated with the additional state 425 is presented. In the example of FIG. 4B, the content 430 associated with the additional state 425 includes the image 415 of the dog and a link 419 to access a source including additional information about the image 415. Hence, the image 415 and the link 425 are components of the content 430. As previously described in conjunction with FIGS. 2 and 3, one or more components of the content 430 of the additional state 425 differ from components of the content 410 of the state 405. In the example of FIGS. 4A and 4B, the image 415 is in both the content 410 and the content 430, while the text content 417 is presented in the content 410 but not in the content 430; similarly, the link 419 is presented in the content 430 but is not presented in the content 410.

### Summary

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
receiving, at a client device, advertisement content having a plurality of states from an online system, different content associated with each state;
presenting content associated with a state of the advertisement content on the client device to a user of the online system;
receiving an input from the user interacting with the content associated with the state of the advertisement content via the client device; and
responsive to the input, presenting content associated with an additional state of the advertisement content to the user via the client device, the content associated with the additional state differing at least in part from the content associated with the state of the advertisement content.

2. The method of claim 1, wherein content associated with the state of the advertisement content comprises one or more components.

3. The method of claim 2, wherein a component is selected from a group consisting of: text data, image data, audio data, video data, a network address, and any combination thereof.

4. The method of claim 2, wherein the content associated with the additional state includes at least one component differing from a component associated with the state.

5. The method of claim 2, wherein a component includes one or more attributes selected from a group consisting of: font type, font size, text color, image color, image size, image resolution, audio volume, video playback speed, video resolution, and any combination thereof.

6. The method of claim 5, wherein the content associated with the state includes a component having an attribute and the content associated with the additional state includes the component having a different attribute.

7. The method of claim 1, wherein the content associated with the additional state includes one or more components not included in the content associated with the state.

8. The method of claim 1, wherein the input comprises contacting a portion of a display device on the client device in which the content associated with the state of the advertisement content is presented with a physical stylus.

9. A method comprising:
receiving a content item for presentation to one or more users of an online system, the content item including a state having one or more components for presentation and including an additional state having one or more additional components for presentation, the additional components of the additional state presented in response to an interaction with the content item;
selecting the content item for presentation to a user of the online system;
communicating the content item to a client device associated with the user for presentation of the state of the content item; and
receiving an indication from the client device of whether the additional state was presented.

10. The method of claim 9, wherein a component is selected from a group consisting of: text data, image data, audio data, video data, a network address, and any combination thereof.

11. The method of claim 9, wherein the one or more additional components included in the additional state include one or more components not included in the one or more components included in the one or more components included in the state.

12. The method of claim 9, wherein an additional component included in the additional state has an attribute differing from an attribute associated with a component included in the state.

13. The method of claim 12, wherein the attribute is selected from a group consisting of: font type, font size, text color, image color, image size, image resolution, audio volume, video playback speed, video resolution, and any combination thereof.

14. The method of claim 9, further comprising:
determining an amount of compensation to request from an entity associated with the content item based at least in part on the received indication.

15. The method of claim 14, wherein the determined amount of compensation is larger if the received indication indicates the additional state was presented than if the received indication indicates the additional state was not presented.

16. The method of claim 14, wherein the entity is an advertiser.

17. The method of claim 14, wherein the determined amount is based at least in part on whether the state and the additional state were presented to the user.

18. A computer program product comprising a computer-readable storage medium having instructions encoded thereon that, when executed by a processor, cause the processor to:
receive a content item for presentation to one or more users of an online system, the content item including a state having one or more components for presentation and including an additional state having one or more additional components for presentation, the additional components of the additional state presented in response to an interaction with the content item;
select the content item for presentation to a user of the online system;
communicate the content item to a client device associated with the user for presentation of the state of the content item; and
receive an indication from the client device of whether the additional state was presented.

19. The computer program product of claim 18, wherein the computer-readable storage medium further has instructions encoded thereon that, when executed by the processor, cause the processor to:
determine an amount of compensation to request from an entity associated with the content item based at least in part on the received indication.

20. The computer program product of claim 19, wherein the determined amount of compensation is larger if the received indication indicates the additional state was presented than if the received indication indicates the additional state was not presented.
